(19) United States
(12) Patent Application Publication
(10) Pub. No.: US 2009/0109006 A1
(43) Pub. Date: Apr. 30, 2009

(54) Media Case Date Indicator

(76) Inventor: Greg Helmstetter, Scottsdale, AZ (US)

Correspondence Address: QUICKPATENTS, INC., 32861 CALLE PERFECTO, SUITE A, SAN JUAN CAPISTRANO, CA, 92675, US

(21) Appl. No.: 11/926,484

(22) Filed: Oct. 29, 2007

(51) Int. Cl. G08B 21/24

(52) U.S. Cl. 340/309.16

(57) ABSTRACT

The present device relates to a media storage case mechanically adjustable time indicator for indicating the due date of media elements. One embodiment of the invention is an adjustable time indicator system for fixing to the media case. An alternate embodiment of the invention is an adjustable time indicator formed into the media case itself. The invention includes multiple embodiments of the time indicator including but not limited to a rotary dial embodiment, a slidable indicator embodiment, a peg hole indicator embodiment, and a deformable button embodiment.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to time indicators, and more particularly to a media storage case time indicator.

### DISCUSSION OF RELATED ART

Time indicators associated with rental media cases are well known in the art. For example, U.S. Pat. No. 6,933,834 to Diggins, Jr. on Aug. 23, 2005 teaches such a device. Such devices are made to remind a consumer when the due date of a rented item is approaching. Despite the development of multiple approaches to remind consumers of rental due dates, these approaches often have significant drawbacks.

Without a reminder, consumers find it difficult to remember the due date of the media rental. Forgetting to return a rental item on time can lead to financial penalties. Therefore, a device to help remind consumers to return rental media on time is needed.

A common approach to this problem is to provide consumers with a paper receipt with the due date printed on the receipt. However, this approach leads to a problem if the receipt is misplaced or lost. A need exists for a device that will not be easily misplaced or lost, and preferably be permanently associated with the media case.

U.S. Pat. No. 6,320,505 to Scott on Nov. 20, 2001 teaches a storage system for video cassette that uses a signaling system as a reminder. This approach addresses the problem of misplacing or losing the reminder. A storage system is less likely to be accidentally lost or misplaced. However, the Scott device requires the consumer to purchase a separate reminder system. Typically, consumers would prefer not to spend money on a reminder system. Consumers would prefer that businesses provide a convenient due date reminder with the rental. A need exists for a device that can be easily incorporated with existing rental systems and does not require consumers to purchase a separate reminder system.

On the other hand, businesses would not be willing to pay for a reminder system, unless it financially benefited the business. Therefore, a reminder system would need to be as economical as possible to minimize the cost to the business, yet be effective enough to attract consumers to provide a benefit to the business. A need exists for a device that minimizes the cost to a business, yet still effectively provides a valued service to the consumer.

U.S. Pat. No. 6,933,834 to Diggins, Jr. on Aug. 23, 2005 teaches an electronic alarm device that reminds a user that the due date and time is approaching on a rented item. The Diggins device also teaches attaching the electronic reminder to the outside of the media case. This approach addresses the problem of keeping the reminder system associated with the media case. Also, the Diggins device can be integrated with a business's rental system, providing a positive feature to the consumer. However, the Diggin's solution involves an electronic device which would be more expensive than a simple mechanical solution, especially if the devices are used on large numbers of media cases as would be the case in a media rental business. Furthermore, the size of the electronic device is not insubstantial and would either make the exterior of media cases bulkier or would be difficult to integrate in a thin media case, such as a DVD case. Therefore, a need exists for a device that is more economical than an electronic system and can be integrated easily with media cases.

U.S. Pat. No. 7,104,448 to Capurso et al. on Sep. 12, 2006 teaches a docking station for reading and writing an electronically writable return reminder tag located on a surface of a rental item. This approach can be easily integrated with media cases. However, the Capurso device requires use of an electronic docking station and technologically sophisticated tags with liquid crystal displays in order to update the due date for each rental. Moreover, the system requires using a computerized inventory control system to identify each media item used with the electronic docking station. This sophisticated and electronic Capurso device does not teach a solution for a more economical and simple mechanical approach. A need exists for a device that not only easily integrates with media cases, but also provides a simple and economical mechanical solution.

Therefore, there is a need for a time indicator device that will help remind consumers to return rental media on time and is not easily misplaced or lost. Preferably the needed device could be permanently associated with the media case. The needed device would further be easily used with existing rental systems and not require consumers to purchase a separate reminder system. Also, the needed device would be economical and minimize the cost to a business, yet still effectively provide a valued service to the consumer. Furthermore, the needed device would provide a simple mechanical solution and be easily integrated with media cases. The present invention accomplishes these objectives.

### SUMMARY OF THE INVENTION

The present device is a media storage case mechanically adjustable time indicator for indicating the due-date of media items. One embodiment of the invention is an adjustable time indicator system for fixing to the media case. An alternate embodiment of the invention is an adjustable time indicator formed into the media case. The preferred embodiment of the invention indicates the day or date the media item is due, however, the invention can also easily indicate an hour or minute time the media item is due.

In the embodiment of the invention for fixing to a media case, the adjustable time indicator system includes a mechanically adjustable time indicator and an attachment means for attaching the time indicator to the media case. A preferred embodiment of the attachment means is an adhesive backing.

The time indicator in one embodiment indicates a numeric day of the month. In another embodiment, the time indicator indicates a day of the week. A preferred embodiment of the time indicator includes an unmarked indicator position to indicate that no due day has been selected. To indicate the days or dates on the invention, demarked indicator positions are used.

In a rotary dial indicator embodiment of the invention, the time indicator is a rotary dial rotationally fixed to an axle base plate of the adjustable time indicator system. The rotary dial includes detent means such that the dial may be selectively placed at one of a plurality of demarked indicator positions. The rotary dial indicates the due day (or date) by rotating to a desired indicator position.

In a slidable indicator embodiment, the time indicator is a peg slidably captured within a linear channel. The linear channel includes detent means such that the peg may be selectively placed at one of a plurality of demarked indicator positions therealong. The peg indicates the due day (or date) by sliding to a desired indicator position.

In a peg hole indicator embodiment, the time indicator is an indicator peg selectively captured within one of a plurality of demarked indicator peg holes in a peg-hole strip. The indicator peg indicates the due day (or date) by placing the indicator peg in one of the peg holes associated with a desired indicator position.

In a deformable button embodiment, the time indicator is a plurality of demarked and deformable button portions. The button portions indicate the due day (or date) by using a finger or tool to manually deform a button portion corresponding to a desired indicator position. To indicate a different day, the selected button portion can be un-deformed by applying force in the opposite direction on the button portion. In another embodiment, the time indicator is substantially air-tight so that a button portion can be un-deformed by pressing a different button portion whereby air pressure forces the previous selection back to the un-selected position.

In an alternate embodiment of the invention, a media storage system includes a media case for selectively holding a media element and a mechanically adjustable time indicator formed into the media case. In a preferred embodiment of the media storage system, the media element is a media disk and the media case is a media disk enclosing shell having an internal side and an external side. In another embodiment, the time indicator is formed into the internal side of the shell. In an alternate embodiment, the time indicator is formed into the external side of the shell. In a preferred embodiment, the external side includes a thin edge portion with the time indicator being formed therein.

In an alternate peg hole indicator embodiment, the time indicator is an indicator peg selectively captured within one of a plurality of demarked indicator peg holes formed into the media case. The indicator peg indicates the due day (or date) by placing the indicator peg in one of the peg holes associated with a desired indicator position.

In an alternate slidable indicator embodiment, the time indicator is a peg slidably captured within a linear channel formed into the media case. The linear channel includes detent means such that the peg may be selectively placed at one of a plurality of demarked indicator positions therealong. The peg indicates the due day (or date) by sliding to a desired indicator position.

In an alternate rotary dial indicator embodiment, the time indicator is a rotary dial rotationally fixed to the media case. The rotary dial includes detent means such that the dial may be selectively placed at one of a plurality of demarked indicator positions. The rotary dial indicates the due day (or date) by rotating to a desired indicator position. The rotary dial snaps onto an axle formed into the media case.

In one embodiment of the detent means, the detent means includes radial bumps on the outer circumference of the axle that are indexed to bumps on the interior of the rotary dial. In an alternate embodiment, the detent means includes notches on the media case radially extending away from the axle that are indexed to bumps on the bottom side of the rotary dial. Both embodiments provide an indexing action to click the rotary dial into place on the desired day (or date) and preventing free rotation without actuation of the rotary dial.

In an alternate deformable button embodiment, the time indicator is a plurality of demarked and deformable button portions formed into the media case. The button portions indicate the due day (or date) by using a finger or tool to manually deform a button portion corresponding to a desired indicator position. To indicate a different day, the selected button portion can be un-deformed by applying force in the opposite direction on the button portion. In another embodiment, the time indicator is substantially air-tight so that a button portion can be un-deformed by pressing a different button portion whereby air pressure forces the previous selection back to the un-selected position.

The present device is a time indicator device that will help remind consumers to return rental media on time by mechanically indicating the due date. The present invention is not easily misplaced or lost and can be permanently associated with the media case. The present device is easily used with existing rental systems and does not require consumers to purchase a separate reminder system. Also, the present device is economical and minimizes the cost to a business, yet still effectively provides a valued service to the consumer. Furthermore, the present invention provides a simple mechanical solution and is easily integrated with media cases. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1A is a top plan view of the invention, illustrating a rotationally adjustable time indicator embodiment attached to a media case;

FIG. 1B is a top plan view of an axle base plate of the rotationally adjustable time indicator embodiment;

FIG. 1C is a top plan view of an assembled rotary dial of the rotationally adjustable time indicator embodiment;

FIG. 1D is an exploded side view of the rotationally adjustable time indicator embodiment;

FIG. 1E is a side view of the assembled rotationally adjustable time indicator embodiment;

FIG. 2A is a top plan view of the invention, illustrating a slidably adjustable time indicator embodiment attached to the media case;

FIG. 2B is a top plan view of the slidably adjustable time indicator embodiment;

FIG. 2C is an exploded side view of the slidably adjustable time indicator embodiment;

FIG. 2D is a side view of the slidably adjustable time indicator embodiment;

FIG. 3A is a perspective view of the invention, illustrating the media case and a peg-indicator embodiment of the invention;

FIG. 3B is a top plan view of indicator peg holes formed into the media case;

FIG. 3C is a cross-sectional view of the invention, taken generally along line 3C of FIG. 3A;

FIG. 3D is an exploded side elevational view of an alternate peg-indicator embodiment of the invention, illustrating a peg indicator, a peg-hole strip, a base plate, and an attachment means;

FIG. 3E is a top plan view of the peg-hole strip and the peg indicator;

FIG. 4A is a perspective view of an alternate slidably adjustable time indicator embodiment of the invention, illustrating a slidably adjustable time indicator formed into the media case;

FIG. 4B is a top plan view of the alternate slidably adjustable time indicator embodiment;

FIG. 4C is partial perspective view of the alternate slidably adjustable time indicator embodiment formed into the media case, taken generally along the lines of 4C of FIG. 4A;

FIG. 5A is a perspective view of the invention, illustrating an alternate rotationally adjustable time indicator embodiment formed into the media case;

FIG. 5B is a top plan view of a rotating disc time indicator;

FIG. 5C is a top plan view of a rotating arrow time indicator;

FIG. 6A is a top plan view of a button-indicator embodiment of the invention, illustrating a plurality of demarked and deformable button portions formed into the media case;

FIG. 6B is a top plan view of the button-indicator embodiment;

FIG. 6C is an exploded side view of the button-indicator embodiment, illustrating a button portion, a base plate and an attachment means; and

FIG. 6D is a side view of the assembled button-indicator embodiment.

### DETAILED DESCRIPTION OF THE PREFERRED EMBODIMENT

### Attachable Embodiments

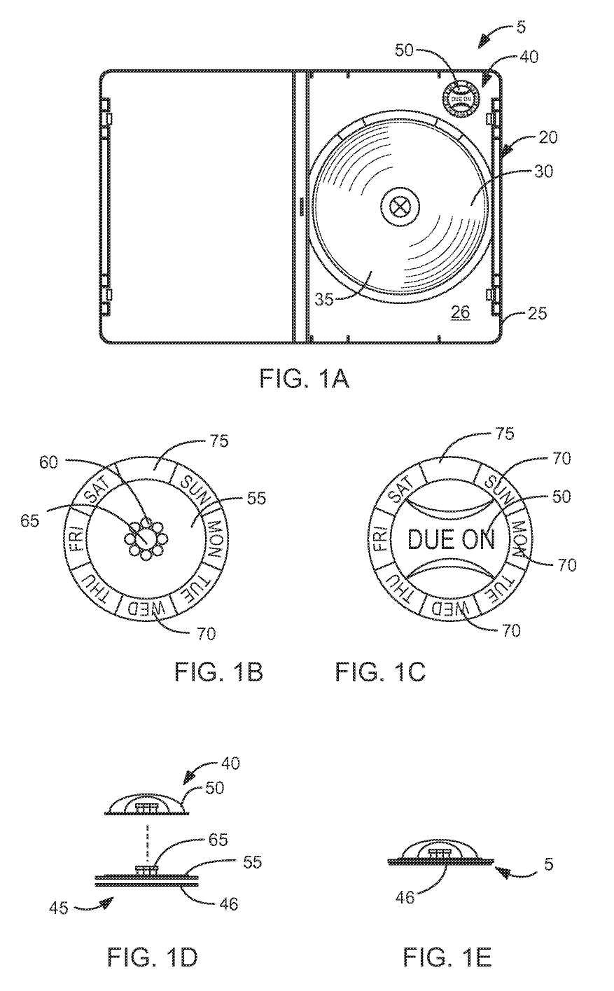

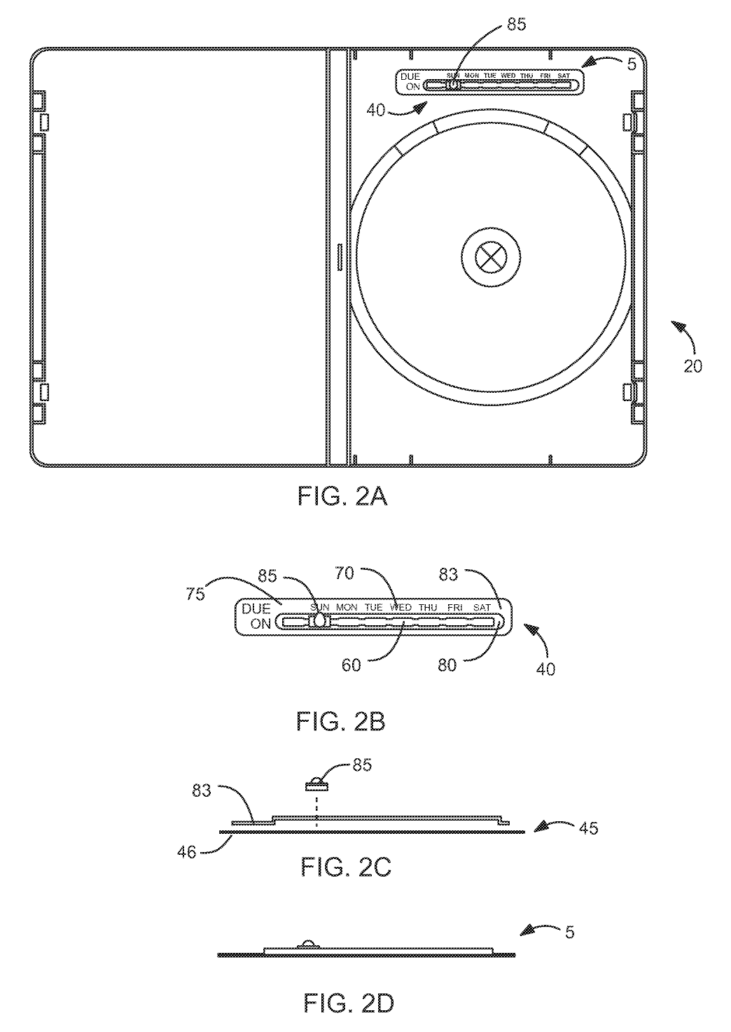

With respect to the drawings, FIGS. 1 & 2 illustrate an adjustable time indicator system 5 for fixing to a media case 20. The adjustable time indicator system 5 includes a mechanically adjustable time indicator 40 and an attachment means 45 for attaching the time indicator 40 to the media case 20. A preferred embodiment of the attachment means 45 is an adhesive backing 46 (FIGS. 1D and 2C). Preferably, the adhesive backing 46 is covered by an easily removable protective strip (not shown) for a user to remove at the time the user decides to attach the adjustable time indicator system 5 to a selected media case 20.

An alternate embodiment of the attachment means 45 is a glue appropriate for attaching the adjustable time indicator system 5 to the media case 20. Other embodiments of the attachment means 45 include clips or other mechanical fasteners (not shown). The adjustable time indicator system 5 is preferably made of a light weight but durable plastic material, but can be made of any suitable light weight and durable material such as a durable cardboard material, if desired. As both the media case 20 and the adjustable time indicator system 5 are likely made of a light weight and durable plastic material, the attachment means 45 is preferably an adhesive backing 46 that is suitable for securely attaching items to such material.

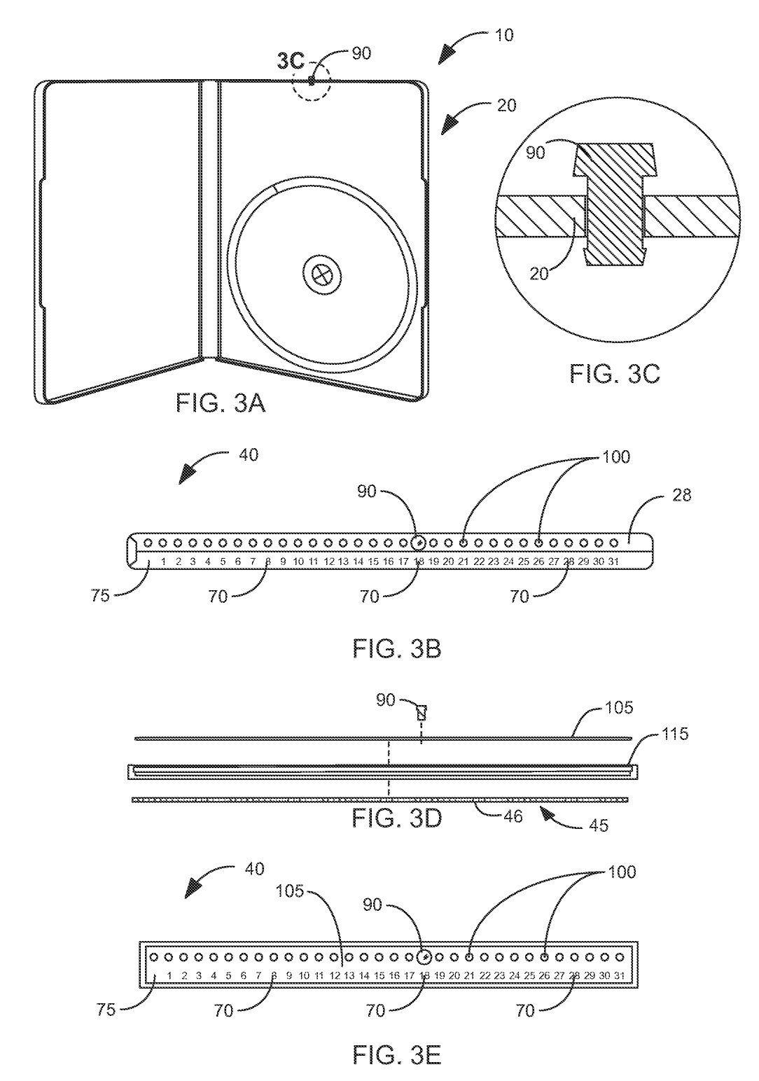

In one embodiment of the invention, the time indicator 40 indicates a numeric day of the month as seen in FIG. 3B. In another embodiment of the invention, the time indicator 40 indicates a day of the week as seen in FIGS. 1B & 2B. A preferred embodiment of the time indicator 40 includes an unmarked indicator position 75 (FIGS. 1B, 2B, & 3B) to indicate that no due day has been selected. Indicating the day of the week requires eight indicator positions (one for each day of the week and one blank “null” position). Indicating the date of the month requires thirty two indicator positions (one for each date of the month and one blank “null” position). The preferred embodiment of the invention indicates the day or date a media element 30 and associated media case 20 (FIG. 1A) are due, however, the invention can also easily indicate an hour or minute time the media element 30 and associated media case 20 are due.

To indicate the days or dates on the invention, demarked indicator positions 70 (FIGS. 1B, 2B & 3B) can be made by using raised or depressed lettering. Other methods to mark the demarked indicator positions 70 include using stickers, printing, or creating apertures in the invention (not shown).

### Rotary Dial Indicator Embodiment

In the embodiment illustrated in FIG. 1A, the time indicator 40 is a rotary dial 50 rotationally fixed to an axle base plate 55 of the adjustable time indicator system 5. The axle base plate 55 is fixed to the media case 20 via the attachment means 45. The rotary dial 50 includes detent means 60, as is known in the art, such that the dial 50 may be selectively placed at one of a plurality of demarked indicator positions 70 (FIGS. 1B & 1C). The rotary dial 50 indicates the due day (or date) by being rotated to a desired indicator position 70. In a preferred embodiment, the rotary dial 50 snaps onto an axle 65 (FIG. 1D) of the axle base plate 55.

In one embodiment illustrated in FIGS. 1B and 1C, the detent means 60 includes radial bumps on the outer circumference of the axle 65 indexed to bumps (not shown) on the interior of the rotary dial 50. In an alternate embodiment, the detent means 60 includes notches (not shown) on the axle base plate 55 radially extending away from the axle 65 that are indexed to bumps (not shown) on the bottom side of the rotary dial 50. Both embodiments provide an indexing action to click the rotary dial 50 into place on the desired day (or date) and preventing free rotation without actuation of the rotary dial 50.

### Slidable Indicator Embodiment

In the embodiment illustrated in FIG. 2A, the time indicator 40 is a peg 85 slidably captured within a linear channel 80. The linear channel 80 includes detent means 60 such that the peg 85 may be selectively placed at one of a plurality of demarked indicator positions 70 therealong. The peg 85 indicates the due day (or date) by sliding to a desired indicator position 70 (FIG. 2B). In one embodiment, the linear channel 80 is created by forming the linear channel 80 in a linear base plate 83 (FIG. 2B). The linear base plate 83 is fixed to the media case 20 via the attachment means 45 (FIG. 2C). This design is preferred because the slidably captured peg 85 is non-removable and therefore minimizes any choking hazard.

### Peg Hole Indicator Embodiment

In an alternate embodiment of the adjustable time indicator system 5, the time indicator 40 is an indicator peg 90 selectively captured within one of a plurality of demarked indicator peg holes 100 in a peg-hole strip 105, illustrated in FIGS. 3D & 3E. The indicator peg 90 indicates the due day (or date) by placing the indicator peg 90 in one of the peg holes 100 associated with a desired indicator position 70. In one embodiment the peg-hole strip 105 is slidably attached to a base plate 115 (FIG. 3D). The base plate 115 is fixed to the media case 20 via the attachment means 45 (FIG. 3D). Using an indicator peg 90 is not preferred because it presents a possible choking hazard and the peg 90 may be easily misplaced.

### Deformable Button Embodiment

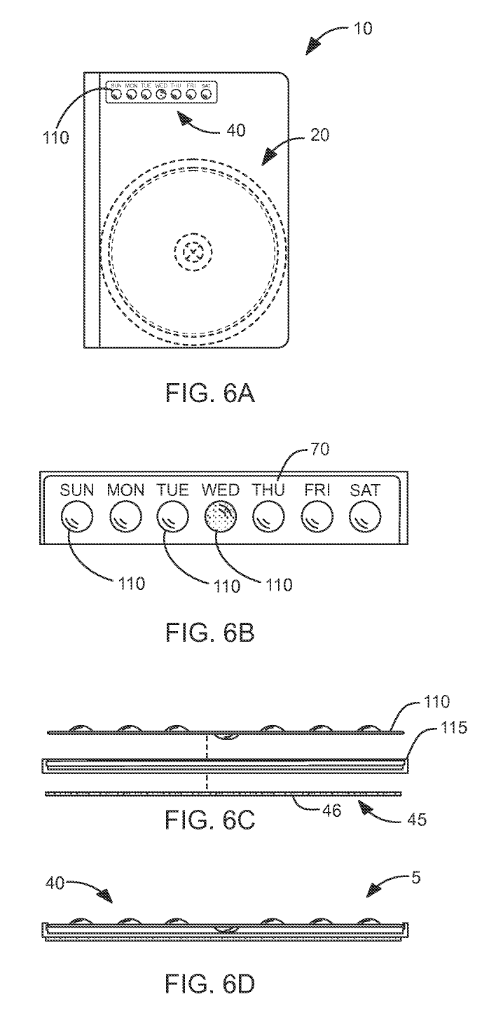

In another alternate embodiment of the adjustable time indicator system 5 illustrated in FIGS. 6C & 6D, the time indicator 40 is a plurality of demarked and deformable button portions 110. The button portions 110 indicate the due day (or date) by using a finger or tool to manually deform a button portion 110 corresponding to a desired indicator position 70 (FIG. 6B). To indicate a different day, the selected button portion 110 can be reformed by applying force in the opposite direction on the button portion 110. In one embodiment, the button portions 110 are removably attached to a base plate 115 (FIG. 6C). The base plate 115 is fixed to the media case 20 via the attachment means 45. Preferably, the button portions 110 are removably slid into the base plate 115 to allow the button portions 110 to be reformed as needed.

### Integrated Embodiments

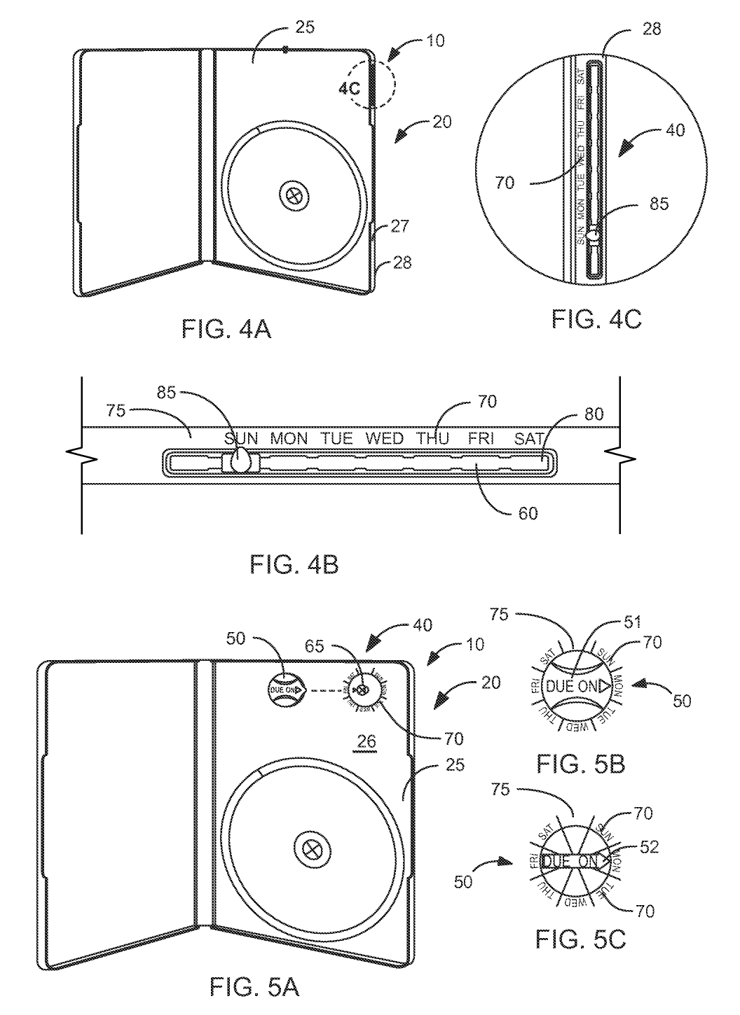

With respect to the drawings, FIGS. 3A, 4A, & 5A illustrate a media storage system 10 including a media case 20 for selectively holding a media element 30 and a mechanically adjustable time indicator 40 formed into the media case 20. The media storage system 10 is preferably made of a light weight but durable plastic material, but can be made of any suitable light weight and durable material, if desired.

In a preferred embodiment illustrated in FIGS. 1A & 4A, the media element 30 is a media disk 35, and the media case 20 is a media disk 35 enclosing shell 25 having an internal side 26 and an external side 27. In the embodiment illustrated in FIG. 5A, the time indicator 40 is formed into the internal side 26 of the shell 25. In an alternate embodiment, the time indicator 40 is formed into the external side 27 of the shell 25. In a preferred embodiment, the external side 27 includes a thin edge portion 28 with the time indicator 40 being formed therein, as illustrated in FIGS. 3B and 4C.

### Peg Hole Indicator Embodiment

In one embodiment of the media storage system 10, illustrated in FIGS. 3A, 3B & 3C, the time indicator 40 is an indicator peg 90 selectively captured within one of a plurality of demarked indicator peg holes 100 formed into the media case 20. The indicator peg 90 indicates the due day (or date) by placing the indicator peg 90 in one of the peg holes 100 associated with a desired indicator position 70 (see FIG. 3B). This embodiment has the advantage of being very economical as it does not require adding any additional structure to the media case 20, but rather only creating multiple apertures for the peg holes 100 and providing an indicator peg 90. This version is not preferred, however, because the indicator peg 90 presents a possible choking hazard and may be easily misplaced.

### Slidable Indicator Embodiment

In an alternate embodiment of the media storage system 10 illustrated in FIGS. 4A, 4B, & 4C, the time indicator 40 is a peg 85 slidably captured within a linear channel 80 formed into the media case 20. The linear channel 80 includes detent means 60 (FIG. 4B) such that the peg 85 may be selectively placed at one of a plurality of demarked indicator positions 70 therealong. The peg 85 indicates the due day (or date) by sliding to a desired indicator position 70.

In one embodiment, the linear channel 80 is formed by creating an aperture in the media case 20 to form the linear channel 80. In another embodiment, the linear channel 80 is created by forming a rectangular raised portion on the surface of the media case 20 and forming a linear channel 80 in that raised portion. In a preferred embodiment, the linear channel 80 is form in the thin edge portion 28, as illustrated in FIG. 4C. This embodiment is preferred because the time indicator 40 can be operated and viewed without opening the case 20. This embodiment is also preferred because the slidably captured peg 85 is non-removable and therefore minimizes any choking hazard.

### Rotary Dial Indicator Embodiment

In another alternate embodiment of the media storage system 10, illustrated in FIG. 5A, the time indicator 40 is a rotary dial 50 rotationally fixed to the media case 20. The rotary dial 50 includes detent means 60 such that the dial 50 may be selectively placed at one of a plurality of demarked indicator positions 70. The rotary dial 50 indicates the due day (or date) by rotating to a desired indicator position 70 (FIGS. 5B & 5C). The rotary dial 50 snaps onto an axle 65 (FIG. 5A) formed into the media case 20. One embodiment of the rotary dial 50 is a rotating disc 51 illustrated in FIG. 5B. An alternate embodiment of the rotary dial 50 is a rotating arrow 52 illustrated in FIG. 5C.

In one embodiment of the detent means 60, the detent means 60 includes radial bumps (not shown) on the outer circumference of the axle 65 that are indexed to bumps on the interior of the rotary dial 50. In an alternate embodiment, the detent means 60 includes notches (not shown) on the media case 20 radially extending away from the axle 65 that are indexed to bumps (not shown) on the bottom side of the rotary dial 50. Both embodiments provide an indexing action to click the rotary dial 50 into place on the desired day (or date) and preventing free rotation without actuation of the rotary dial 50.

### Deformable Button Embodiment

In the embodiment illustrated in FIG. 6A, the time indicator 40 is a plurality of demarked and deformable button portions 110 formed into the media case 20. The button portions 110 indicate the due day (or date) by using a finger or tool to manually deform a button portion 110 corresponding to a desired indicator position 70 (see FIG. 6B). To indicate a different day, the selected button portion 110 can be reformed by applying force in the opposite direction on the button portion 110. The button portions 110 can be formed into the media case 20 on any side of the media case 20. Preferably, the button portions 110 are formed into the media case 20 so that when the media case 20 is closed the indicator positions 70 can still be viewed. In another embodiment, the time indicator 40 is substantially air-tight so that a button portion 110 can be un-deformed by pressing a different button portion 110 whereby air pressure within the time indicator 40 forces the previous selection back to the un-selected position.

While a particular form of the invention has been illustrated and described, it will be apparent that various modifications can be made without departing from the spirit and scope of the invention. For example, the linear channel 80 could alternately be formed into the internal side 26 of the media case 20. Also, peg holes 100 could be formed into the front side of the media case 20. Accordingly, it is not intended that the invention be limited, except as by the appended claims.

What is claimed is:

1. An adjustable time indicator system for fixing to a media case comprising:
a mechanically adjustable time indicator; and
an attachment means for attaching the time indicator to the media case.

2. The adjustable time indicator system of claim 1 wherein the time indicator indicates a numeric day of the month.

3. The adjustable time indicator system of claim 1 wherein the time indicator indicates a day of the week.

4. The adjustable time indicator system of claim 1 wherein the time indicator is a rotary dial rotationally fixed to an axle base plate of the adjustable time indicator system.

5. The adjustable time indicator system of claim 1 wherein the time indicator is a peg slidably captured within a linear channel.

6. The adjustable time indicator system of claim 1 wherein the time indicator is an indicator peg selectively captured within one of a plurality of demarked indicator peg holes.

7. The adjustable time indicator system of claim 1 wherein the time indicator is a plurality of demarked and deformable button portions.

8. A media storage system comprising:
a media case for selectively holding a media element; and
a mechanically adjustable time indicator formed into the media case.

9. The media storage system of claim 8 wherein the time indicator indicates a numeric day of the month.

10. The media storage system of claim 8 wherein the time indicator indicates a day of the week.

11. The media storage system of claim 8 wherein the media element is a media disk, and the media case is a media disk enclosing shell having an internal side and an external side.

12. The media storage system of claim 8 wherein the time indicator is formed into the internal side of the media disk enclosing shell.

13. The media storage system of claim 8 wherein the time indicator is formed into the external side of the media disk enclosing shell.

14. The media storage system of claim 13 wherein the external side includes a thin edge portion, the time indicator being formed therein.

15. The media storage system of claim 8 wherein the time indicator is a rotary dial rotationally fixed to the media case.

16. The media storage system of claim 15 wherein the rotary dial includes detent means such that the dial may be selectively placed at one of a plurality of demarked indicator positions.

17. The media storage system of claim 8 wherein the time indicator is a peg slidably captured within a linear channel.

18. The media storage system of claim 17 wherein the linear channel includes detent means such that the peg may be selectively placed at one of a plurality of demarked indicator positions therealong.

19. The media storage system of claim 8 wherein the time indicator is an indicator peg selectively captured within one of a plurality of demarked indicator peg holes formed into the media case.

20. The media storage system of claim 8 wherein the time indicator is a plurality of demarked and deformable button portions formed into the media case.
